(19) United States
(12) Patent Application Publication
(10) Pub. No.: US 2011/0212306 A1
(43) Pub. Date: Sep. 1, 2011

(54) FORMED ENTITIES FROM FLEXIBLE SHEET MATERIALS

(76) Inventors: John P. Whitlock, Lebanon, OR (US); Stephan R. Clark, Albany, OR (US); Scott Lerner, Corvallis, OR (US); Karl S. Weibezahn, Corvallis, OR (US)

(21) Appl. No.: 12/714,689

(22) Filed: Mar. 1, 2010

(51) Int. Cl. B32B 1/00; B29C 65/52

(52) U.S. Cl. 428/174; 156/196

(57) ABSTRACT

Apparatus and methods are provided. A first sheet of flexible material is placed against a surface of a form. The first sheet bears an adhesive on one side. A second sheet of flexible material is brought into contact with the adhesive and the two sheets are pressed into conformant contact with the surface of the form. The first and second sheets are thus bonded to form a rigid or semi-rigid entity having a cross-sectional shape in accordance with the surface contours of the form.

### BACKGROUND

Photovoltaic (PV) cells are used to derive electrical energy directly from incident light, typically sunlight. Reflective concentrating troughs are known that capture and direct light onto the receiving surface of the PV cell or cells. In this way, the electrical yield from the PV cells is increased at a reduced cost-per-unit-area relative to that of increasing the size of the PV cells themselves.

However, known light concentrating troughs are typically formed from metal, glass mirrors or other materials associated with undesirably high production costs. Furthermore, it is desired to reduce the cost of fabricating other devices directed to solar and light propagation endeavors. The present teachings address the foregoing concerns.

### BRIEF DESCRIPTION OF THE DRAWINGS

The present embodiments will now be described, by way of example, with reference to the accompanying drawings, in which:

FIG. 1 depicts a plan view of a forming device according to one embodiment;

FIG. 2 depicts a plan view of a forming device according to another embodiment;

FIG. 3 depicts a plan view of a forming device according to yet another embodiment;

FIG. 4 depicts an isometric view of a portion of a formed entity in accordance with the embodiment of FIG. 3;

FIG. 5 depicts a flow diagram of a method according to one embodiment;

FIG. 6 depicts a flow diagram of a method according to another embodiment;

### DETAILED DESCRIPTION

### Introduction

Means and methods related to forming curved rigid entities from flexible sheet materials are provided. A first sheet of flexible material is placed against a surface of a form. The first sheet bears an adhesive on one side. A second sheet of flexible material is brought into contact with the adhesive and the two sheets are pressed into conformant contact with the surface of the form. The first and second sheets are thus bonded to form a rigid or semi-rigid entity having a cross-sectional shape in accordance with the surface contours of the form.

In one embodiment, a method includes supporting a bonding agent on a side of a first sheet of flexible material. The method also includes positioning a side of a second sheet of flexible material in contact with the bonding agent. The method also includes pressing the first and second sheets of flexible material into conformant contact with a surface of a form so as to bond the first sheet of flexible material to the second sheet of flexible material. An at least semi-rigid formed entity is thus defined.

In another embodiment, an apparatus includes a first sheet of material, and a second sheet of material bonded to the first sheet of material. The bonding is such that a formed entity is defined. The formed entity is defined by a cross-section that is at least partially curvilinear.

### First Illustrative Device

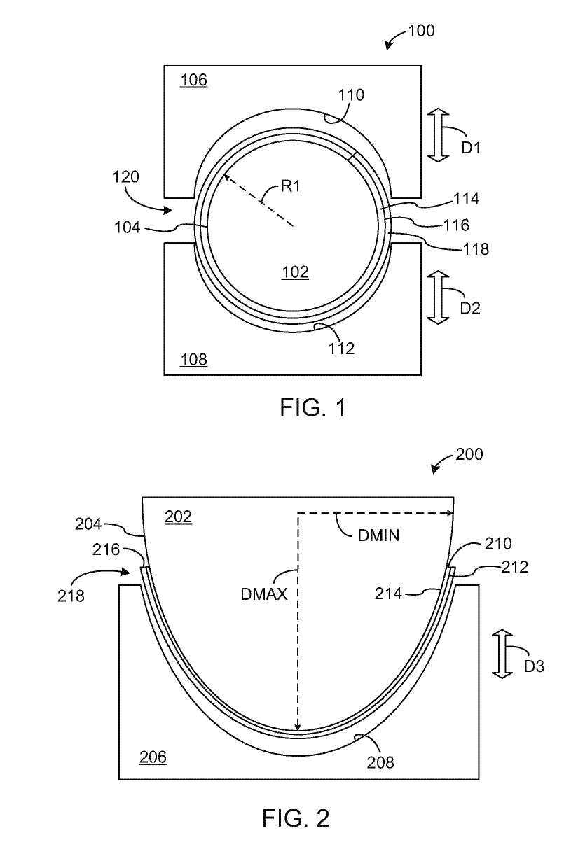

Reference is now directed to FIG. 1, which depicts a plan view of a forming device 100. The device 100 is illustrative and non-limiting with respect to the present teachings. Thus, other devices can be configured, constructed or operated in accordance with the present teachings.

The device 100 includes a central form (or form) 102. The form 102 is depicted end-on and is understood to be defined by a length extending normal to the drawing page. The form 102 is also defined by a circular (or disk-like) cross-section characterized by a radius “R1”. The form 102 can be made from any suitable rigid material such as, for non-limiting example, steel, copper, glass, brass, aluminum, etc. Other suitable materials can also be used. In another embodiment (not shown), the form 102 is formed from tubing or pipe and thus defines a central longitudinal cavity.

The form 102 includes an outer surface 104. The surface 104 is understood to be smooth in character. The surface 104 is defined by an area in accordance with the cylindrical shape of the form 102. Specifically, the area of the surface 104 is equal to the circumference times the length of the form 102.

The device 100 includes a first clamp 106 and a second clamp 108. The first and second clamps 106 and 108 are defined by respective surfaces 110 and 112 that are complimentary to respective portions of the surface 104 of the form 102. In this way, the first and second clamps 106 and 108 are configured to press sheet materials into compliant contact with the surface 104 of the form 102. The first and second clamps 106 and 108 can be respectively formed from any suitable rigid material such as those named above in regard to the form 102.

Operation of the device 100 is illustrated as follows: a first sheet of flexible material 114 is placed generally about the form 102. The first sheet 114 bears an adhesive (or bonding agent) on an outward-facing side 116. A second sheet of flexible material 118 is then placed about the first sheet 114 and into contact with adhesive on side 116. It is noted that the first sheet 114 is characterized by a first length slightly greater than the circumference of the form 102. In turn, the second sheet 118 is characterized by a second length slightly greater than the length of the first sheet 114. That is:

Form 102 circumference<Sheet 114 length<Sheet 118 length

The first and second clamps 106 and 108 are then brought toward the form 102 as depicted by the directional arrows “D1” and “D2”. The first and second sheets of material 114 and 118 are thus pressed into compliant contact with the surface 104 of the form 102. Pressed contact is maintained for a predetermined period of time (e.g., fifteen seconds, sixty seconds, etc.) while the adhesive on side 116 bonds (or laminates) the first sheet 114 to the second sheet 118. The clamps 106 and 108 are thereafter drawn away from the form 102.

The pressed adhesive bonding of the first sheet 114 to the second sheet 118 results in (or defines) a formed entity 120. The formed entity 120 is at least semi-rigid and maintains (or substantially so) a cross-sectional form defined by that of the form 102. Thus, the formed entity 120 is characterized by a circular cross-sectional shape. The formed entity 120 is now removed from the forming device 100 and subject to further processing, applied to a task, etc.

The device 100 is used to make rigid or semi-rigid formed entities (e.g., 120) from sheet materials (e.g., 114 and 118) that are initially flexible. Specifically, the formative operation is as follows: Recall that sheets 114 and 118 are of respectively different original lengths, being incrementally greater than the circumference of the form 102. The formative process results in a tensile stressing of (inner) sheet 114 and a compressive stressing of (outer) sheet 118 as the respective sheet ends are brought into coincidence. The bonding of stressed sheet 114 to stressed sheet 118 results in a neutral stress axis at the interface (i.e., side 116) of the two sheets. The respective stresses (compressive and tensile) cause the formed entity 120 to retain the circular cross-sectional shape after the forming process is complete.

The first sheet 114 and second sheet 118 can be formed from any suitable flexible sheet (or film) materials. In one embodiment, the first sheet 114 and second sheet 118 are formed from polyethylene terephthalate (PET) having a thickness of zero-point-zero-zero-three (0.003) inches, while the adhesive borne on side 116 is formed from a cyanoacrylate material. Other suitable flexible materials and adhesives can also be used.

Either or both of the first sheet 114 and second sheet 118 can support a reflective material. For non-limiting example, the first sheet 114 can support a reflective material on the side opposite side 116 such that the formed entity 120 can be used as a light pipe. That is, such a formed entity 120 would be characterized by a reflective inner-wall surface configured to propagate light by way of internal reflections. Other suitable configurations can also be defined and used.

### Second Illustrative Device

Reference is now directed to FIG. 2, which depicts a plan view of a forming device 200. The device 200 is illustrative and non-limiting with respect to the present teachings. Thus, other devices can be configured, constructed or operated in accordance with the present teachings.

The device 200 includes a central form (or form) 202. The form 202 is depicted end-on and is understood to be defined by a length extending normal to the drawing page. The form 202 is also defined by a parabolic (or semi-parabolic) cross-section characterized by minimum dimension “DMIN” and a maximum dimension “DMAX”. The form 202 can be made from any suitable rigid material such as, for non-limiting example, steel, copper, glass, brass, aluminum, etc. Other suitable materials can also be used. In another embodiment (not shown), the form 202 is formed from a rigid sheet-like material and thus defines a central longitudinal cavity (or trough). The form 202 includes an outer surface 204. The surface 204 is understood to be smooth in character. The surface 204 is defined by an area by virtue of the cross-sectional shape and length of the form 202.

The device 200 includes a clamp 206. The clamp 206 is defined by a surface 208 complimentary to at least some of the surface 204 of the form 202. That is, the surface 208 is configured to define by a parabolic trough. In this way, the clamp 206 is configured to press sheet materials into compliant contact with the surface 204 of the form 202. The clamp 206 can be formed from any suitable rigid material such as those named above in regard to the form 202.

Operation of the device 200 is illustrated as follows: a first sheet of flexible material 210 is placed generally about a portion of the form 202. The first sheet 210 bears an adhesive on an outward-facing side 212. Optionally, the first sheet 210 bears a reflective material on some or all of an inward-facing side 214. A second sheet of flexible material 216 is then placed into contact with the adhesive on side 212 of first sheet 210.

The clamp 206 is then brought toward the form 202 as depicted by the directional arrow “D3”. The first and second sheets of material 210 and 216 are thus pressed into compliant contact with the surface 204 of the form 202, by way of the clamp 206 surface 208. Pressed contact is maintained for a predetermined period of time (e.g., twenty seconds, etc.) while the adhesive on side 212 bonds the first sheet 210 to the second sheet 216. The clamp 206 is then drawn away from the form 202.

The pressed adhesive bonding of the first sheet 210 to the second sheet 216 results in (or defines) a formed entity 218. The formed entity 218 is at least semi-rigid and maintains (or substantially so) a cross-sectional form defined by that of the form 202. Thus, the formed entity 218 is characterized by a parabolic cross-sectional shape. The formed entity 218 is now removed from the forming device 200 and subject to further processing, applied to a task, etc. In one embodiment, one or more sides (or edges) of the formed entity 218 are trimmed or suitably shaped after removal from the forming device 200.

### Third Illustrative Device

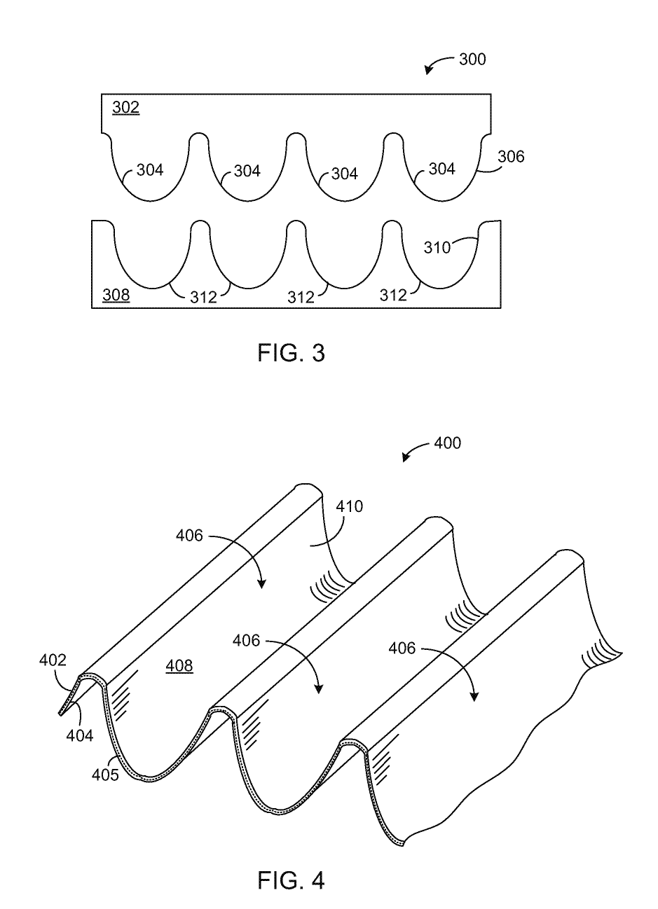

Reference is now directed to FIG. 3, which depicts plan view of forming device 300. The device 300 is illustrative and non-limiting with respect to the present teachings. Thus, other devices can be configured, constructed or operated in accordance with the present teachings.

The device 300 includes a central form (or form) 302. The form 302 is depicted end-on and is understood to be defined by a length extending normal to the drawing page. The form 302 is also defined by a generally serpentine cross-sectional shape characterized by plurality of spaced, parabolic ridges or extensions 304. The parabolic extensions 304 and other depicted features collectively define a surface 306 of the form 302. The surface 306 is defined by an area by virtue of the cross-sectional shape and length of the form 302. Additionally, the surface 306 is understood to be smooth in character.

The form 302 can be made from any suitable rigid material such as, for non-limiting example, steel, copper, glass, brass, aluminum, etc. Other suitable materials can also be used. In another embodiment (not shown), the form 302 is formed from a rigid sheet-like material and thus defines a plurality of longitudinal cavities (or troughs).

The device 300 includes a clamp 308. The clamp 308 is defined by a surface 310 complimentary to at least some of the surface 306 of the form 302. That is, the surface 310 is configured to define a serpentine cross-section, having a plurality of parabolic troughs 312. In this way, the clamp 308 is configured to press sheet materials into compliant contact with the surface 306 of the form 302. The clamp 308 can be formed from any suitable rigid material such as those named above in regard to the form 302.

Operation of the device 300 is substantially the same as described above in regard to the device 200. As such, two sheets of flexible material are bonded together by adhesive and pressed into compliant contact with the surface 306 by way of the clamp 308. Further description of the resulting formed entity is provided below in association with the embodiment of FIG. 4.

### First Illustrative Formed Entity

Attention is now directed to FIG. 4, which depicts an isometric view of a portion of a formed entity 400. The formed entity 400 is made in accordance with normal operation of the forming device 300. The formed entity 400 is illustrative and non-limiting with respect to the present teachings. Other formed entities having respectively varying dimensions, cross-sectional shapes, etc., are also contemplated by the present teachings.

The formed entity 400 includes a first sheet of material 402 bonded to a second sheet of material 404. Such bonding is accomplished by way of a suitable adhesive or cement 405. In one or more embodiments, no heating is required to bond the first sheet 402 to the second sheet 404, and such bonding is performed at normal ambient temperatures (e.g., seventy degrees Fahrenheit, etc.). The first and second sheets 402 and 404 can be defined by any suitable flexible sheet or film-like material such as PET, polypropylene, etc.

The formed entity 400, by virtue of the device 300, is defined by a plurality of parallel, parabolic troughs 406. The formed entity 400 includes a reflective material 408 supported on one side 410 of the first sheet 402. The reflective material 408 faces generally inward to the respective parabolic troughs 406. Without limitation, the reflective material 408 can be applied to (or borne by) the first sheet 402 either before or after the pressed bonding of the formed entity 400 by way of the device 300.

The formed entity 400 is generally rigid or at least semi-rigid in character. This is true despite the initially flexible nature of the first and second sheets 402 and 404. The formed entity 400 can be applied, for non-limiting example, to support one or more photovoltaic cells within each of the parabolic troughs 406. The reflective material 408 operates to direct incident light onto such PV cells so that increased electrical yield is achieved, relative to operating the same PV cells without the formed entity 400.

In another illustrative application, light sources such as light emitting diodes (LEDs) can be arranged and supported within the respective parabolic troughs 406. In such an embodiment, a light directing or projecting device is defined. Other uses for the formed entity 400 are also contemplated by the present teachings.

### First Illustrative Method

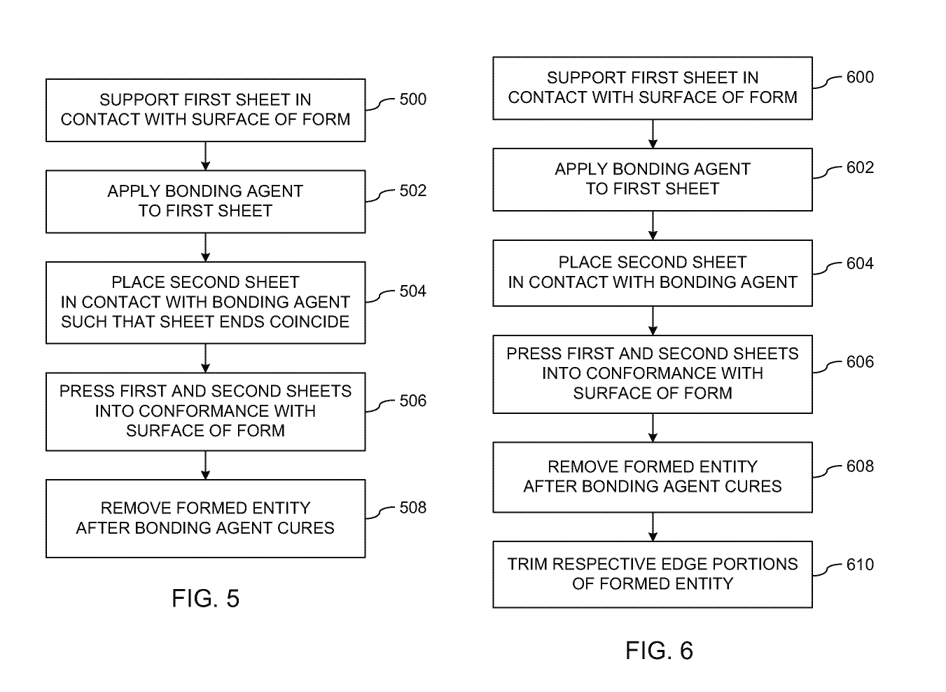

Attention is now directed to FIG. 5, which depicts a method according to one embodiment of the present teachings. The method of FIG. 5 depicts particular method steps and an order of execution. However, it is to be understood that other methods including other steps, omitting one or more of the depicted steps, or proceeding in other orders of execution are also contemplated. Thus, the method of FIG. 5 is illustrative and non-limiting with respect to the present teachings. Reference is made to FIG. 1 in the interest of understanding the method of FIG. 5.

At 500, a first flexible sheet is placed in contact with surface of a form. For purposes of non-limiting illustration, it is assumed that a sheet 114 of flexible material, such as PET, is placed in contact with a surface 104 of a form 102.

At 502, a bonding agent is applied to a side of the first sheet. For purposes of the present illustration, it is assumed that a bonding agent, such as cyanoacrylate, is applied to a side 116 of the first sheet 114.

At 504, a second flexible sheet is placed in contact with the bonding agent of the first sheet, the respective sheet being aligned (or registered) such that opposite ends of the respective sheets coincide. For purposes of the present illustration, a sheet 118 of flexible material, such as PET, is placed in contact with the bonding agent on side 116 of sheet 114. It is understood that the respective sheets 114 and 118 have different lengths such that their ends coincide when wrapped around the form 102. As such, sheet 118 is longer than sheet 114 in accordance with form 102 radius R1 and the respective thicknesses of sheets 114 and 118.

At 506, the first and second sheets are pressed in to conformant contact with the surface of the form. For purposes of the present illustration, respective clamps 106 and 108 are moved in toward the form 102 so as to apply a generally even pressure to the sheets 114 and 118 and the bonding agent there between. The sheets 114 and 118 conform to the shape of the surface 104 of the form 102. The contact pressure is maintained for a predetermined period of time such as a few seconds, etc. The sheets 114 and 118 are thus bonded together to define a formed entity 120.

At 508, the formed entity is removed after the bonding agent cures. For purposes of the present illustration, it is assumed that the clamps 106 and 108 are withdrawn away from the form 102. The formed entity 120 is then slidably removed from the form 102. The formed entity 120 defines a tube-like object being at least semi-rigid in nature and maintaining the circular cross-sectional shape as defined by the form 102.

### Second Illustrative Method

Attention is now directed to FIG. 6, which depicts a method according to one embodiment of the present teachings. The method of FIG. 6 depicts particular method steps and an order of execution. However, it is to be understood that other methods including other steps, omitting one or more of the depicted steps, or proceeding in other orders of execution are also contemplated. Thus, the method of FIG. 6 is illustrative and non-limiting with respect to the present teachings. Reference is made to FIGS. 3 and 4 in the interest of understanding the method of FIG. 6.

At 600, a first flexible sheet is placed in contact with a surface of a form. For purposes of non-limiting illustration, it is assumed that a sheet 402 of flexible material, such as PET, is placed in contact with a surface 306 of a form 302.

At 602, a bonding agent is applied to a side of the first sheet. For purposes of the present illustration, it is assumed that a bonding agent 405, such as cyanoacrylate, is uniformly applied to a side of the first sheet 402.

At 604, a second flexible sheet is placed in contact with the bonding agent of the first sheet. For purposes of the present illustration, a sheet 404 of flexible material, such as PET, is placed in contact with the bonding agent 405 supported by the sheet 402. It is understood that the respective sheets 402 and 404 need not have specifically defined length differentials, provided that each is long enough to form the resulting entity.

At 606, the first and second sheets are pressed in to conformant contact with the surface of the form. For purposes of the present illustration, a clamp 308 is moved in toward the form 302 so as to apply a generally even pressure to the sheets 402 and 404 and the bonding agent 405 there between. The sheets 402 and 404 conform to the shape of the surface 306 of the form 302. Contact pressure is maintained for a predetermined period of time. The sheets 402 and 404 are thus bonded together to define a formed entity 400.

At 608, the formed entity is removed after the bonding agent cures. For purposes of the present illustration, it is assumed that the clamp 308 is withdrawn away from the form 302. The formed entity 400 is then removed away from the form 302. The formed entity 400 defines series of parallel, parabolic troughs being at least semi-rigid in nature.

At 610, one or more edge portions of the formed entity are trimmed. For purposes of the ongoing illustration, it is assumed that some amount of scrap material is cut away or otherwise removed from the formed entity 400 so as to define a predetermined peripheral shape. The formed entity 400 can now go on to additional process steps, by applied to a task, etc.

In general and without limitation, the present teachings contemplate various apparatus and methods for forming rigid or semi-rigid entities from flexible sheet materials. A first sheet or film of material is placed generally against a form. The form is defined by surface contours in accordance with a desired cross-sectional shape of a resulting formed entity. The first sheet either bears an adhesive or bonding agent material, or such is then applied to an outward-facing side of the first sheet.

A second sheet of flexible material is brought into contact with the adhesive borne by the first flexible sheet. The first and second sheets are then pressed into compliance (i.e., conformant contact) with the surface of the form by way of one or more corresponding clamps. Pressure is maintained until the adhesive has sufficiently set or cured. The altered material stresses of the bonded first and second sheets result in a formed entity that is rigid or semi-rigid in nature, in contrast to the flexible characteristics of the original constituent materials. The formed entities can then be further processed or machined, applied to various tasks, etc.

The flexible sheet materials can be variously selected and can be transparent, translucent, opaque, etc. Furthermore, a reflective material such as aluminum, silver, etc., can be applied to at least one of the flexible sheets or borne thereon before the entity forming processes of the present teachings. Parabolic light concentrators, propagating light-pipes and other formed entities can be manufactured by way of the present teachings.

In general, the foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. A method, comprising:
supporting a bonding agent on a side of a first sheet of flexible material;
positioning a side of a second sheet of flexible material in contact with the bonding agent; and
pressing the first and second sheets of flexible material into conformant contact with a surface of a form so as to bond the first sheet of flexible material to the second sheet of flexible material thus defining an at least semi-rigid formed entity.

2. The method according to claim 1, the pressing including bringing respective opposite ends of the first and second sheets of flexible material into coincidence.

3. The method according to claim 1, the surface of the form configured such that a cross-section of the form is at least partially circular, semi-circular, elliptical, parabolic, semi-parabolic, truncated parabolic, or serpentine.

4. The method according to claim 1, the formed entity defined by a cross-section in accordance with the surface of the form.

5. The method according to claim 1, the pressing the first and second sheets of flexible material into conformant contact with the surface of the form performed by way of one or more clamps.

6. The method according to claim 5, at least one of the one or more clamps defined by a clamp surface conformant to at least a portion of the surface of the form.

7. The method according to claim 1, the first sheet of flexible material defined by a first length, the second sheet of flexible material defined by a second length that is greater than the first length.

8. The method according to claim 1, the formed entity defining one or more parabolic troughs.

9. The method according to claim 1 further comprising supporting a reflective material on at least a portion of the formed entity.

10. The method according to claim 1 further comprising applying a reflective material to at least a portion of the first sheet of flexible material or the second sheet of flexible material.

11. The method according to claim 1 further comprising pressing the first and second sheets of flexible material at a temperature lesser than one-hundred twenty degrees Fahrenheit.

12. An apparatus, comprising:
a first sheet of material; and
a second sheet of material bonded to the first sheet of material so that a formed entity is defined, the formed entity defined by a cross-section that is at least partially curvilinear.

13. The apparatus according to claim 12 further comprising a reflective material supported on at least a portion of the formed entity.

14. The apparatus according to claim 12, the cross-section of the formed entity being at least partially circular, semi-circular, elliptical, parabolic, semi-parabolic, truncated parabolic, or serpentine

15. The apparatus according to claim 12, the first sheet of material bonded to the second sheet of material by way of an adhesive, or a bonding agent.
